(19) United States
(12) Patent Application Publication
(10) Pub. No.: US 2006/0087260 A1
(43) Pub. Date: Apr. 27, 2006

(54) Integrated circuit configuration for triggering power semiconductor switches

(76) Inventors: Reinhard Herzer, Ilmenau (DE); Thomas Stockmeier, Nurnberg (DE)

Correspondence Address: Andrew F. Young, Esq.;Lackenbach Siegel, LLP, One Chase Road, Scarsdale, NY, 10583, US

(21) Appl. No.: 11/247,319

(22) Filed: Oct. 11, 2005

(30) Foreign Application Priority Data
Oct. 13, 2004 (DE) 10 2004 049 817.2

(51) Int. Cl. H05B 41/36

(52) U.S. Cl. 315/291

(57) ABSTRACT

Presented is an integrated circuit configuration for triggering single power semiconductor switches, or power semiconductor switches in half-bridge configuration. The circuit configuration consists of a first integrated trigger chip having a plurality of function groups comprising at least one first level shifter for a switch at higher potential and at least one second integrated trigger chip having a plurality of function groups comprising at least one second level shifter and a driver for this switch. The at least one trigger chip is connected downstream of the first trigger chip, the ground potential of the second trigger chip is at the output potential of the level shifter of the first trigger chip, and the trigger chips are arranged in a common housing with suitable isolation of the trigger chips against each other.

### DESCRIPTION

Presented is an integrated circuit configuration for triggering power semiconductor switches arranged as single switches or in a bridge circuit. These types of bridge configurations of power semiconductor switches are known as single-phase, two-phase or three-phase half-bridge circuits or H-bridge circuits, wherein the single-phase half bridge represents a base module of electronic power circuits. In a half-bridge circuit, two power switches consisting of a first, so-called TOP switch and a second, so-called BOT switch are arranged in a series connection. A half bridge of this type, as a rule, incorporates a connection to an intermediate direct-current circuit. The center tap is typically connected to a load.

If the power switch is designed with a power semiconductor component or with a plurality of the same kind of power semiconductor components connected in series, a triggering circuit is necessary to trigger the power switches. These triggering circuits, as a rule, according to the prior art, consist of multiple partial circuits or function blocks. The trigger signal coming from a superordinate control unit is prepared in a first partial circuit, which is the trigger logic, and routed via additional components to the driver circuits and ultimately to the trigger input of the respective power switch. In the case of half-bridge arrangements with higher intermediate-circuit voltages, for example greater than 100V, the trigger logic is separated in terms of potential/galvanic means from the driver circuits for preparation of the trigger signals, since the associated power switches are at different potentials relative to each other, rendering an isolation in terms of voltage unavoidable. This separation according to the prior art is accomplished by

means of transformers, opto-couplers, or optical waveguides. This galvanic separation applies at least to the TOP switch, but in the case of higher power levels it is also performed for the BOT switch because of a possible distortion of the ground potential during the switching process.

Also known are integrated circuit configurations for power switches of the voltage classes up to 600V that dispense with an extreme galvanic separation. They are monolithically integrated circuits, wherein, according to the prior art, level shifters, for example in so-called SOI (Silicon-on-Isolator [sic]) technology, are used for the galvanic separation of the trigger logic from the actual driver circuit. For higher voltage classes this technology is available in technically limited form and only at significant cost.

Also known is the monolithic integration of the trigger logic, as well as of the driver circuits by means of “junction isolation”. This technology is available up to the voltage class 1200V. However, this type of design of the integrated circuit configuration is very complex from a production aspect, and accordingly just as expensive. Additionally, there are technical problems, for example with leakage currents and latch-up effects, among other things, at higher temperatures (>125° C. operating temperature), as well as due to distortion of the ground potential in the case of fast dynamic processes.

The invention is based on the object of presenting an integrated circuit configuration that uses known production technologies while being useable for higher voltage classes than is customary with these production technologies, and that at the same time is also suitable for use at higher operating temperatures above 125° C.

This object is met according to the invention with the measures represented by the characteristics of claims 1 or 2. Preferred embodiments are described in the subclaims.

The inventive integrated circuit configuration serves for triggering power semiconductor switches arranged as single switches or in a bridge circuit. The bridge circuit is the more common application in this context, which is why it will be primarily considered below. In bridge circuits, the TOP switch and BOT switch are switched in series and connected to an intermediate direct-current circuit and a load. The bridge circuit may be designed in different forms, for example as a single phase, two-phase or three-phase half bridge, or also as a three-phase bridge with an additional power switch, the so-called brake chopper. Depending upon the design of the bridge circuit, the inventive integrated circuit configuration has a first integrated trigger chip and at least one second integrated trigger chip. The first trigger chip comprises a plurality of function groups, among them the trigger logic and at least one driver of a BOT switch and at least one first level shifter for a TOP switch. The at least one second integrated trigger chip contains a plurality of function groups, among them, according to the invention, at least one second level shifter and one driver of a TOP switch. According to the invention, the at least one second trigger chip is connected downstream of the first. The ground potential of the respective second trigger chip is at the output potential of the level shifter of the first trigger chip for the respective TOP switch. The first and the at least one second trigger chip are advantageously arranged in a common housing with suitable isolation of all trigger chips against each other.

In the case in which a single switch is being controlled, a driver for a BOT switch is, of course, not included in the circuit configuration, but only the level shifter(s) for the power switch(es) that are at the other potential.

The inventive idea will be explained in more detail based on the example embodiments in FIGS. 1 through 4.

FIG. 1 shows a circuit configuration for triggering power semiconductor switches according to the prior art.

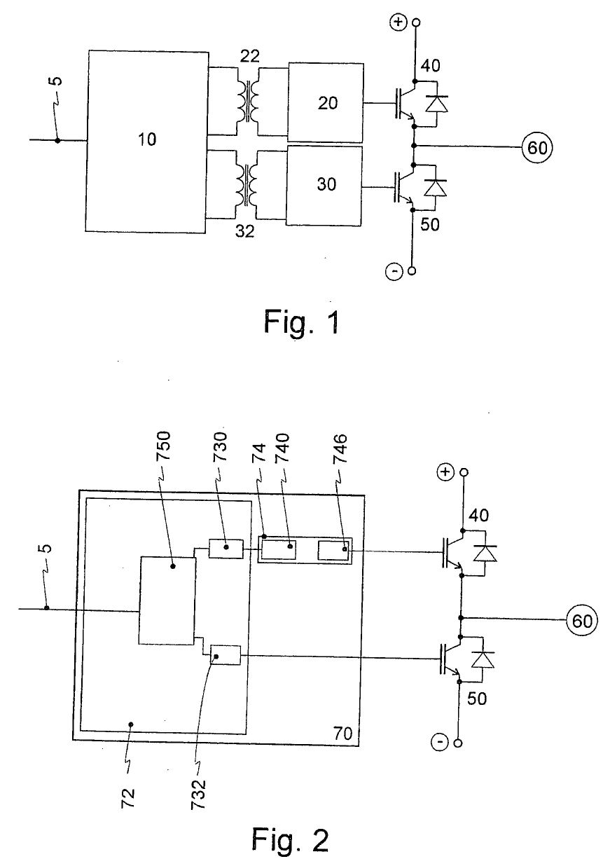

FIG. 2 shows an inventive circuit configuration for triggering power semiconductor switches for a half-bridge circuit of the power switches.

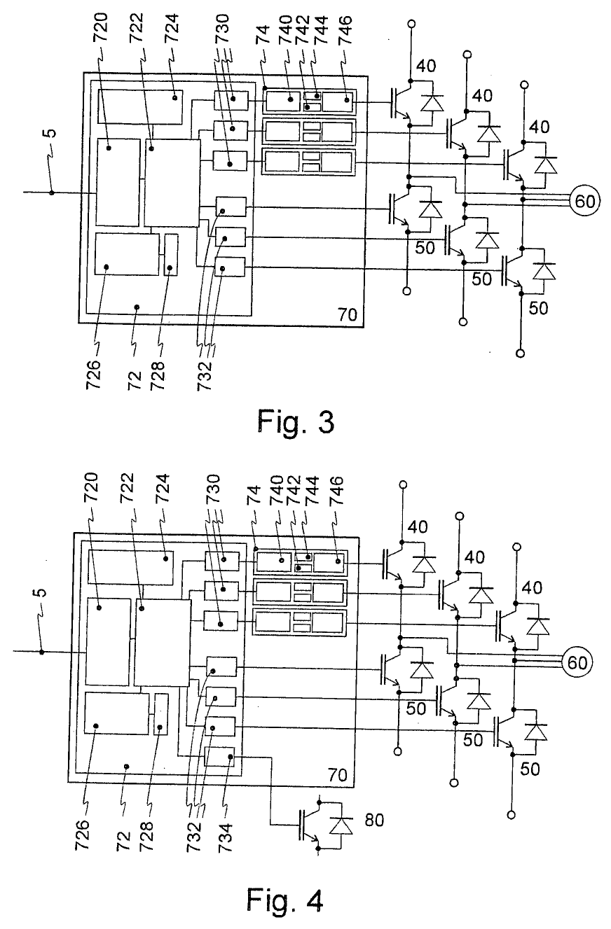

FIG. 3 shows an inventive circuit configuration for triggering power semiconductor switches for a three-phase bridge circuit of the power switches.

FIG. 4 shows an inventive circuit configuration for triggering power semiconductor switches for a three-phase bridge circuit with brake chopper.

FIG. 1 shows a circuit configuration for triggering power semiconductor switches according to the prior art. Shown is a half-bridge circuit consisting of a first power switch (40), which is the TOP switch, and a second power switch (50), which is the BOT switch, connected in series with the former. Both switches, in turn, consist of a power transistor in each case, for example an IGBT (Insulated Gate Bipolar Transistor) and a freewheeling diode switched anti-parallel thereto, or alternatively a MOS-FET. According to the prior art, the respective power switch may also consist of a plurality of IGBTs switched in parallel and a plurality of freewheeling diodes switched anti-parallel thereto, or analogously a plurality of MOS-FETs.

The trigger inputs, the gates of the respective transistors, are connected to a driver circuit. The TOP switch (40) has assigned to it in this case the driver circuit (20), and the BOT switch (50) has assigned to it the driver circuit (30). During operation the two power switches are at different potentials, which is why the two driver circuits (20, 30) must be arranged electrically isolated from one another.

The control signals (5) of a superordinate control are prepared in the trigger logic circuit (10) and transmitted galvanically separated to the driver circuits. To provide for the galvanic separation, the trigger logic (10) and driver circuits (20, 30) have connected between them the transmitters (22, 32) in this case. In certain applications, for example in cases of low-power applications, the transmitter (32) to the driver (30) of the BOT switch (50) is dispensed with. The trigger logic (10) and the BOT driver (30) are then at the same potential.

FIG. 2 shows an inventive circuit configuration for triggering power semiconductor switches for a half-bridge circuit configuration of these power switches. The half-bridge circuit configuration is identical to the one in FIG. 1. Provided as the power switches (40, 50) in this case are IGBTs of the voltage class 1200V.

The control signals (5) of the superordinate control unit are processed according to the invention by a single module and routed to the gates of the respective power switches (40, 50). The module, in turn, consists of two trigger chips (72, 74) that are arranged isolated from one another in a common housing (70). The first trigger chip (72) comprises a logic assembly (750), a driver (732) for the BOT switch (50), as well as a first level shifter (730) for a TOP switch. The output of this level shifter is connected to the input of a second trigger chip (74). It comprises a second level shifter (740), as well as the driver (746) of the TOP switch (40).

The signal between the logic assembly (750) and driver (746) of the TOP switch (40) is thus raised to the required potential by means of two level shifters (730, 740). Since the first level shifter (730) is an integral component of the first trigger chip (72) and the second level shifter (740) is an integral component of the second trigger chip (74), only half the maximum voltage must be surmounted on each trigger chip (72, 74) as a potential difference. The ground potential of the first trigger chip (72) may, for example, vary between 0V and 600V in this case, and that of the second trigger chip (72, 74) between 600V and 1200V. This means that 600V-isolation processes according to the prior art, for example SOI, can be used on the respective trigger chip (72, 74). Since both trigger chips (72, 74) are arranged isolated against each other, double the potential difference, as compared to the potential difference within one trigger chip (72, 74) in the entire integrated circuit configuration, is thus surmounted. In the example embodiment an inventive integrated circuit configuration (70) for the voltage class 1200V is implemented using an internal isolation within the trigger chips (72, 74) of 600V.

FIG. 3 shows an inventive circuit configuration for triggering power semiconductor switches for a three-phase bridge circuit of the power switches. The three-phase bridge circuit is made up of three half-bridge circuits identical to the one in FIG. 1. The three-phase bridge circuit has three TOP as well as three BOT switches in each case that are also implemented as IGBTs of the voltage class 1200V. The load (60) may, for example, be implemented as a tri-phase electric motor.

The control signals (5) of the superordinate control unit are processed according to the invention by a single module (70) and routed to the gates of the respective power switches (40, 50) of the three-phase bridge circuit. The module (70), in turn, consists of four trigger chips (72, 74), which are arranged isolated against each other in a common housing (70). The first trigger chip (72) is illustrated here at a level of greater complexity as compared to FIG. 2 and comprises the function groups consisting of voltage regulator (724), input interface (720), processing logic (722), fault management (726) and protective circuit (728), as well as three drivers (732) for the BOT switches (50) and three level shifters (730) for the TOP switches (40) of the three-phase bridge circuit. The outputs of the level shifters (730) are connected to the inputs of three second trigger chips (74). They comprise in each case a level shifter (740), a signal reconstruction (742), a processing logic, and a protective circuit (744), as well as the driver (746) of the respective TOP switch (40).

The signal between the processing logic (722) and driver (726) of the TOP switch (40), in turn, is raised to the necessary potential by means of two level shifters (730, 740). The first level shifter (730) is an integral component of the first trigger chip (72) and the second level shifter (740) is an integral component of the respective second trigger chip (74), wherein the output potential of the respective second trigger chip (74) during operation is at different potentials between 600V and 1200V, and this potential varies during the operating time. Isolation processes according to the prior art may also be used on the respective trigger chip (72, 74) in a case in which a three-phase bridge circuit is controlled. Since all trigger chips (72, 74) are arranged isolated against each other, this also makes it possible, like in the example embodiment according to FIG. 2, to surmount twice the potential difference, as compared to the potential difference within one trigger chip (72, 74) in the entire integrated circuit configuration (70).

FIG. 4 shows an inventive circuit configuration for triggering power semiconductor switches for a three-phase bridge circuit with brake chopper. A seventh power switch (80) is provided for this purpose in addition to the three TOP and three BOT switches (50). This seventh switch (80) serves as control unit during operation for a so-called brake chopper, which serves to drain excess electric energy in a circuit, for example, from the negative line of the electric motor (60). To trigger the power switch (80) for the brake chopper, the first trigger chip has, as compared to the one according to FIG. 3, an additional driver (734) that is at the same potential as the drivers (732) of the BOT switches (50).

1-8. (canceled)

9. An integrated circuit configuration for triggering power semiconductor switches comprising:
a circuit configuration consisting of a first integrated trigger chip having a plurality of function groups comprising at least one first level shifter for a switch, and at least one second integrated trigger chip having a plurality of function groups comprising at least one second level shifter and a driver for said switch, wherein the at least one second trigger chip is connected downstream of the first trigger chip; and
a ground potential of the second trigger chip is at the output potential of the level shifter of the first trigger chip and each said trigger chips are arranged in a common housing with suitable isolation of the trigger chips against each other.

10. An integrated circuit configuration for triggering first and second power semiconductor switches comprising:
an arrangement wherein said first and second power semiconductor switches are respectively arranged in a bridge circuit as TOP and BOT switches connected to an intermediate direct-current circuit and a load, wherein the circuit configuration consists of a first integrated trigger chip having a plurality of function groups comprising at least one driver of a BOT switch and at least one first level shifter for a TOP switch, and at least one second integrated trigger chip having a plurality of function groups comprising at least one second level shifter and one driver of a TOP switch, wherein the at least one second trigger chip is connected downstream of the first; and
a ground potential of the second trigger chip being at the output potential of the level shifter of the first trigger chip, and the trigger chips are arranged in a common housing with suitable isolation of the trigger chips against each other.

11. A circuit configuration according to claim 9, wherein:
a power semiconductor switch has one or a plurality of identical power semiconductor components, such as IGBTs with a freewheeling diode arranged anti-parallel to the same, or MOSFETs.

12. A circuit configuration according to claim 9, wherein:
the first integrated trigger chip has the additional function groups consisting of a voltage regulator, an input interface, a processing logic, fault management, and a protective circuit.

13. A circuit configuration according to claim 9, wherein:
a second integrated trigger chip has the additional function groups consisting of signal reconstruction, processing logic, and protective circuit.

14. A circuit configuration according to claim 9, wherein:
the output potential of the first level shifter varies between 0 and 600V above the ground potential of the first integrated trigger chip.

15. A circuit configuration according to claim 10, wherein:
the circuit configuration has, for triggering the power semiconductor switches of a half-bridge circuit configuration consisting in each case of one TOP and one BOT switch, a first and second trigger chip.

16. A circuit configuration according to claim 10, wherein:
the circuit configuration has, for triggering the power semiconductor switches of a 3-phase bridge circuit configuration, a first trigger chip with three BOT drivers and three level shifters, as well as three second trigger chip, in each case with a level shifter and a TOP driver.
